(19) United States
(12) Patent Application Publication
(10) Pub. No.: US 2006/0101180 A1
(43) Pub. Date: May 11, 2006

(54) Multiprocessor system comprising an observation element

(76) Inventor: Walter Tuppa, Wien (AT)

Correspondence Address: Siemens Corporation;Intellectual Property Department, 170 Wood Avenue South, Iselin, NJ, 08830, US

(21) Appl. No.: 10/513,343

(22) PCT Filed: Apr. 15, 2003
(86) PCT No.: PCT/EP03/03929

§ 371 Date: Aug. 2, 2005

(30) Foreign Application Priority Data
Apr. 29, 2002 (EP) 02009665.7

(51) Int. Cl. G06F 13/24

(52) U.S. Cl. 710/260; 710/100

(57) ABSTRACT

The invention relates to a multiprocessor system, which comprises memory elements, input/output units and a central bus system, whereby the input/output units access the memory elements via the central bus system, using direct memory access. Said system is equipped with a bus observation element, which during the read/write access by an input/output unit to a memory element via the central bus system monitors and evaluates the memory addresses that have been generated by the input/output unit and uses said addresses to generate interrupts in individual processors. This allows the computing capacity to be increased during the parallel processing of tasks.

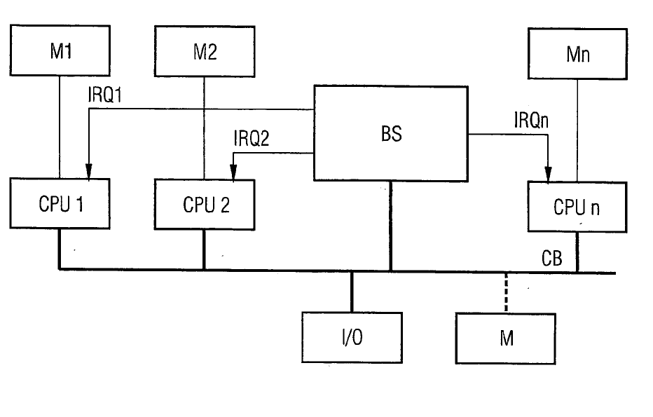

### CROSS REFERENCE TO RELATED APPLICATIONS

This application is the US National Stage of International Application No. PCT/EP03/03929, filed Apr. 15, 2003 and claims the benefit thereof. The International Application claims the benefits of European application No. 02009665.7, filed Apr. 29, 2002, both applications are incorporated by reference herein in their entirety.

### FIELD OF INVENTION

The invention relates to a multiprocessor system, which comprises memory elements, input/output units and a central bus system and whereby the input/output units access the memory elements via the central bus system, using direct memory access.

### SUMMARY OF THE INVENTION

In order to deal with the ever increasing demands on the computing capacity of processor systems, which demands cannot be solved by increasing processor capacity alone, multiprocessor systems are used. In these multiprocessor systems, the processes to be handled are structured in part tasks so as to enable parallel and hence accelerated processing.

Hereby, communication between the individual processing elements is one of the essential contributors to processing efficiency. This communication must be achieved as efficiently as possibly, i.e. the outlay for data exchange must be minimized.

A standard form of communication is data exchange via shared memory elements, whereby a processing element puts the data to be transmitted into a predefined storage area from where it can be read by the receiving element. If processes are uniformly structured, the read prompt can operate by recurring periodically, or by using interrupt. The latter method is used, above all, in communication between peripheral components and one or several processors, in order to synchronize the processor activity with the non-periodic and hence unpredictable receipt of data.

Thereby, the program currently running is interrupted, and a special interrupt processing program (Interrupt Handler) is called up, which checks whether there is actually data present and implements the data acceptance. In systems where a single peripheral element, such as an input/output unit, sends data to several processors and, to do so, only generates unspecific interrupts, each of the processors has to interrupt its current program at each interrupt so as to determine whether the data is destined for it. It is this that significantly reduces the performance of a multiprocessor system where communication technology applications have to process large quantities of data. In addition, this is also especially important as, when a system is being planned, one must also assume the worst case scenario and, therefore, appropriate safety margins must be provided for.

Therefore, the task of the invention is to give a solution that enables the interrupt processing to be carried out efficiently.

This task is solved according to the invention using a multiprocessor system of the type mentioned at the beginning. The said system is equipped with a bus observation element, which, during the read/write access by an input/output unit to a memory element via the central bus system, monitors and evaluates the memory addresses that have been generated by the input/output unit and uses said addresses to generate interrupts in individual processors.

In order to identify and process interrupts, modern (RISC) processors generally just need a few As of time (quitting the current program, saving the registry data, stack change, . . . and restore).

As, however, a very high number of interrupts occur where there are high data rates to packet switching systems such as computer networks, the invention spreads the interrupt load caused by an input/output unit across the processors, i.e. each processor only gets an interrupt if data is already there for it. This also prevents unnecessary bus access by the processors and further increases the performance capacity of the multiprocessor system.

It is of advantage if the central bus system is constructed to PCI standard. PCI (Peripheral Component Interconnect) is a bus standard for local data bus systems, i.e. for linking microprocessors directly. At a clock rate of 33/133 MHz, the standard has a data transfer speed of 132-1064 Mbyte/s. The bus width is 32/64 Bits.

Possible alternatives to this are also other bus systems that make the defined memory address available to the bus observation unit. These include, for example, bus systems to the following standards: RAPID I/O, local processor bus systems such as PPC60x bus protocol or MPX bus protocol for Risc PowerPC processors.

It is of benefit if an input/output unit accesses a memory element via the central bus system using direct memory access (DMA).

A special type of direct memory access is designated as the DMA, whereby the memory access is not carried out by the processor allocated to this memory but by an own DMA module. This process is faster than if the processor has to handle the memory access itself.

It is of advantage if the bus observation element is designed as an application specific integrated circuit (ASICs). ASICS require less space and consume less power than standard components.

Alternatively, the bus observation element can also be designed as a field programmable gate array, a solution that lends itself especially to small scale implementation.

Standard processors using the RISC principle, i.e. with a reduced instruction set, or CISC processors, signal processors or also appropriately programmed ASICs can be used as processors, i.e. as data processing elements.

The invention is explained in greater detail by reference to a FIGURE, which shows a block diagram of an exemplary embodiment of the multiprocessor system according to the invention.

### BRIEF DESCRIPTION OF THE DRAWING

The sole FIGURE shows a block diagram of an exemplary embodiment of the multiprocessor system according to the invention.

### DETAILED DESCRIPTION OF INVENTION

The multiprocessor system illustrated includes, in addition to the processors CPU1, CPU2, . . . CPUn, memory elements M1, M2, . . . Mn, input/output units I/O, a central bus system CB, as well as a bus observation element BS according to the invention.

What is not illustrated are elements necessary for the function and whose existence is taken for granted, such as power supply, clock generator TS, user interfaces for displaying the operating state and for programming the board and the monitoring device U.

A non-volatile memory realized using EEPROMs can be provided to store assembly specific data. A microcontroller can be realized in an additional non-volatile memory made up of ROM or Flash Memory elements to control the processor run-up.

32 Mbytes SDRAM are provided as memory M and equipped with DRAM or SDRAM memory elements, each element having a minimum storage capacity of 32 Mbytes.

Most of the input/output components available have themselves only one single interrupt at their disposal, and, hence, the use of this interrupt has to be shared for all the processors via a so-called PCI Bridge. In addition, the PCI Standard defines 4 interrupt sources per bus, each of which is assigned to an input/output unit I/O. If more input/output units I/O are provided on a PCI Bus, then, perforce, these must share one PCI interrupt.

All standard (fast) input/output units I/O are DMA capable, i.e. they can load data from the memory M1, M2 . . . Mn in order to process it, or they can store it there, and can do so independently of the processor. Further, status information is also often saved to a defined storage location using DMA, as write operations are much faster than read operations in modern bus systems. In this way the processor can read this information directly from the (fast) memory.

The bus observation element BS monitors and evaluates this DMA access, and with the help of the memory addresses in question, a corresponding interrupt IRQ1, IRQ2, . . . , IRQn is generated for a specific processor and forwarded to the processor via an interrupt component, which can also be integrated into the processor.

By means of a suitable memory layout, i.e. the appropriate assignment of the storage area to the individual processors, the demands on the logic of the bus observation element BS can be kept to a minimum.

The embodiment is used as a gateway for data exchange between modem connections as per the ATM 25 standard, and users of a Local Area Network as per the Ethernet standard. The gateway's job includes converting payload, as well as the essential data for the call-processing, i.e. the essential information for setting up, removing and controlling the connection and signaling data for ensuring the operability of performance features or service features (maintenance).

The data is received via an ATM (Asynchronous Transfer Mode) connection, independent of modem pool cards, via ATM 25 (ATM transmission with 25.6 Mbps) and an ATM switching center, processed by several processors and forwarded via several Ethernet interfaces to an Ethernet switch, whereby each processor processes its packages independently of the other processors. One processor deals with all the call processing and maintenance data, the others process-the payload packages.

In this case, the input/output unit is an ATM-SAR component with its own PCI interface and DMA capability. Each processor is assigned a memory of its own, which can be read and written to by the input/output unit I/O via the PCI Bridge assigned to each processor. The bus observation unit observes the address information on the 64 bit wide PCI BUS and from said addresses generates interrupts for the respective processor.

1.-5. (canceled)

6. A multiprocessor system, comprising:
a plurality of memory elements;
a plurality of input/output units;
a central bus system, wherein the input/output units access the memory elements via the central bus system, using direct memory access; and
a bus observation element, wherein the bus observation element during a read/write access by an input/output unit to a memory element via the central bus system monitors and evaluates the memory addresses that have been generated by the input/output unit and uses said addresses to generate interrupts in individual processors.

7. The multiprocessor system according to claim 6, wherein at least one of the input/output units is equipped with an interface driver for Ethernet.

8. The multiprocessor system according to claim 6, wherein the central bus system is designed according to the PCI standard.

9. The multiprocessor system according to claim 7, wherein the central bus system is designed according to the PCI standard.

10. The multiprocessor system according to claim 6, wherein the bus observation element is designed as an Application Specific Integrated Circuit.

11. The multiprocessor system according to claim 7, wherein the bus observation element is designed as an Application Specific Integrated Circuit.

12. The multiprocessor system according to claim 8, wherein the bus observation element is designed as an Application Specific Integrated Circuit.

13. The multiprocessor system according to claim 6, wherein the bus observation element is designed as a field programmable gate array.

14. The multiprocessor system according to claim 7, wherein the bus observation element is designed as a field programmable gate array.

15. The multiprocessor system according to claim 8, wherein the bus observation element is designed as a field programmable gate array.
